(19) United States
(12) Patent Application Publication
(10) Pub. No.: US 2026/0175237 A1
(43) Pub. Date: Jun. 25, 2026

(54) WATER OUTLET DEVICE, FAUCET AND SHOWER HEAD

(71) Applicant: FUJIAN XIHE SANITARY WARE TECHNOLOGY CO., LTD., Nan'an, QuanZhou (CN)

(72) Inventors: Xiaofa Lin, Nan'an QuanZhou (CN); Xiaoshan Lin, Nan'an QuanZhou (CN); Zhiwei Chen, Nan'an QuanZhou (CN); Qiqiao Liu, Nan'an QuanZhou (CN); Xiaoqing Deng, Nan'an QuanZhou (CN); Pansheng Liang, Nan'an QuanZhou (CN)

(73) Assignee: FUJIAN XIHE SANITARY WARE TECHNOLOGY CO., LTD., Nan'an, QuanZhou, FJ (CN)

(21) Appl. No.: 18/832,565

(22) PCT Filed: Apr. 18, 2023
(86) PCT No.: PCT/CN2023/089057

§ 371 Date: Jul. 24, 2024

(30) Foreign Application Priority Data
Feb. 27, 2023 (CN) 202310170593.5

(51) Int. Cl. B05B 1/18

(52) U.S. Cl. CPC B05B 1/182

(57) ABSTRACT

A water outlet device includes a jet disk and a cover body. The jet disk includes a disk body, and the disk body has a first disk surface and a second disk surface that are opposite to each other. The jet disk further includes a nozzle part provided on the disk body and extending out of the second disk surface. The nozzle part includes a sidewall and a bottom wall enclosing a hollow cavity, and the bottom wall of the nozzle part is provided with a water outlet hole. The cover body includes a cover plate which is installed cooperatively with the disk body to form a water inlet channel, the cover plate has a first plate surface and a second plate surface that are opposite to each other.

### CROSS-REFERENCE TO RELATED APPLICATIONS

The present application is a U.S. National Phase Entry of International Application No. PCT/CN2023/089057 having an international filing date of Apr. 18, 2023, which claims priority to Application No. 202310170593.5 filed to the CNIPA on Feb. 27, 2023. Contents of the above-identified applications are incorporated into the present application by reference.

### TECHNICAL FIELD

The present application relates to, but is not limited to, the field of water outlet devices, and particularly relates to, but is not limited to, a water outlet device, a faucet, and a shower head.

### BACKGROUND

Water outlet components such as shower head and faucet usually adopt rubber water outlet nozzles with fine holes at the water outlet end in order to achieve the descaling and the outlet water effect of drizzling. Using the rubber water outlet nozzle, there is a problem that the outlet water shape is unstable, which affects user experience.

### SUMMARY

The following is a summary of the subject matter described in detail herein. This summary is not intended to limit the scope of protection of the claims.

An embodiment of the present disclosure provides a water outlet device, including a jet disk and a cover body. The jet disk includes a disk body, the disk body has a first disk surface and a second disk surface that are opposite to each other, the jet disk further includes a nozzle part provided on the disk body and extending out of the second disk surface, the nozzle part includes a sidewall and a bottom wall enclosing a hollow cavity, and the bottom wall of the nozzle part is provided with a water outlet hole.

The cover body includes a cover plate which is installed cooperatively with the disk body to form a water inlet channel, the cover plate has a first plate surface and a second plate surface that are opposite to each other, and the cover body further includes an extension part extending from the second plate surface toward the first disk surface and extending into the hollow cavity of the nozzle part. A water jet channel is formed by an outer wall surface of the extension part and an inner wall surface of the sidewall of the nozzle part, and a water outlet end of the water jet channel communicates with the water outlet hole.

An embodiment of the present disclosure also provides a faucet, which includes the water outlet device as described above, and the water outlet device is provided at a water outlet end of the faucet.

An embodiment of the present disclosure also provides a shower head, which includes the water outlet device as described above, and the water outlet device is provided at a water outlet end of the shower head.

Other aspects may be understood upon reading and understanding the drawings and detailed description.

### BRIEF DESCRIPTION OF DRAWINGS

The accompanying drawings are used to provide further understanding of the technical solutions of the present disclosure, and constitute a part of the specification. They are used to explain the technical solutions of the present application together with the embodiments of the present disclosure and do not constitute a limitation on the technical solutions of the present application.

FIG. 1 is a schematic three-dimensional exploded view of a water outlet device according to an embodiment of the present disclosure.

FIG. 2 is another perspective view of FIG. 1.

FIG. 3 is a cross-sectional view of a first design form of a water outlet hole of a water outlet device along an axial direction according to an embodiment of the present disclosure.

FIG. 4 is a cross-sectional view of a water outlet device in a radial direction at a disk body position according to an embodiment of the present disclosure.

FIG. 5 is a three-dimensional view of a nozzle part of a water outlet device according to an embodiment of the present disclosure.

FIG. 6 is a cross-sectional view of a water outlet device in a radial direction at a nozzle part according to an embodiment of the present disclosure.

FIGS. 7A-7D are schematic views of various arrangement forms of a water outlet hole of a nozzle part of a water outlet device according to an embodiment of the present disclosure.

FIGS. 8A-8F are schematic views of various design forms of a groove of a water outlet device according to an embodiment of the present disclosure.

FIG. 9 is a cross-sectional view of a second design form of a water outlet hole of a water outlet device along an axial direction according to an embodiment of the present disclosure.

FIG. 10 is a schematic view of an outlet water shape of a first design form of a water outlet hole of a water outlet device according to an embodiment of the present disclosure.

FIG. 11 is a schematic view of an outlet water shape of a third design form of a water outlet hole of a water outlet device according to an embodiment of the present disclosure.

FIG. 12 is a schematic view of a faucet according to an embodiment of the present disclosure.

FIG. 13 is a partially enlarged view of FIG. 12.

FIG. 14 is a schematic view of a shower head according to an embodiment of the present disclosure.

FIG. 15 is a partially enlarged view of FIG. 14.

### REFERENCE SIGNS

100—water outlet device; 1—jet disk; 10—disk body; 11—nozzle part; A—hollow cavity; 111—sidewall; 112—bottom wall; 1120—water outlet hole; 2—cover body; 20—cover plate; 21—extension part; 110A—annular stop part; 110B—spray tube part; 101A—countersunk groove; 101B—through hole; 1011—inner wall surface; 210—groove; 113—protruding part; 1130—tapered protrusion; 220—tapered groove; B—water inlet channel; 3—water jet channel; 102—projection; 200—faucet; 300—shower head.

### DETAILED DESCRIPTION

Technical solutions in the embodiments of the present disclosure will be clearly and completely described with reference to the drawings in the embodiments of the present disclosure. Apparently, the described embodiments are only part of and not all of the embodiments of the present disclosure. Based on the embodiments of the present disclosure, all other embodiments obtained by those of ordinary skills in the art without making creative efforts fall within the protection scope of the present disclosure.

In addition, the technical solutions in different embodiments of the present disclosure can be combined with each other, but it must be based on the realization by those of ordinary skill in the art. When the combination of the technical solutions is contradictory or cannot be realized, it should be considered that the combination of the technical solutions does not exist and is not within the protection scope required by the present disclosure.

In the description of the present disclosure, it is to be understood that the orientations or position relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, and the like are based on those shown in the drawings, which are only for convenience of describing the present disclosure and simplifying the description and are not intended to indicate or imply that the referred device or element must have a particular orientation, or is constructed and operated in a particular orientation and therefore cannot be construed as limiting on the present disclosure.

Furthermore, the terms “first”, “second” are only used for descriptive purposes and cannot be understood to indicate or imply relative importance or imply the number of technical features indicated.

In the description of the present disclosure, unless otherwise explicitly specified and defined, terms “mounting”, “connection”, “fixing” should be understood in a broad sense, for example, it may be a fixed connection or may be a detachable connection, or may be an integral connection; it can be a mechanical connection, or may be an electrical connection, or may be in a communication with each other; it may be a direct connection, or an indirect connection through an intermediate medium, or it may be an internal communication between two elements or interaction between the two elements. For those of ordinary skills in the art, specific meanings of the above terms in the present disclosure can be understood according to specific situations.

In the present disclosure, unless otherwise explicitly specified and defined, a first feature being “above” or “below” a second feature may include direct contact between the first feature and the second feature, or it may also include the first feature and the second feature not being in direct contact but being in contact through other features between them. Moreover, the first feature being “on”, “above” and “over” the second feature includes that the first feature being directly above or obliquely above the second feature, or simply indicates that the first feature is horizontally higher than the second feature. The first feature being “under”, “below” and “underneath” the second feature includes that the first feature is directly below or obliquely below the second feature, or simply means that a horizontal height of the first feature is less than that of the second feature.

Various different implementations or examples are provided below to implement different structures of the present disclosure. In order to simplify the disclosure of the present disclosure, components and settings of particular examples are described below. Of course, they are examples only and are not intended to limit the present disclosure. In addition, the present disclosure may repeat reference numbers and/or reference letters in different examples, and such repetition is for purposes of simplification and clarity, and does not indicate the relationship between the various embodiments and/or settings discussed. In addition, the present disclosure provides examples of various specific processes and materials, but those of ordinary skills in the art may be aware of the application of other processes and/or the use of other materials.

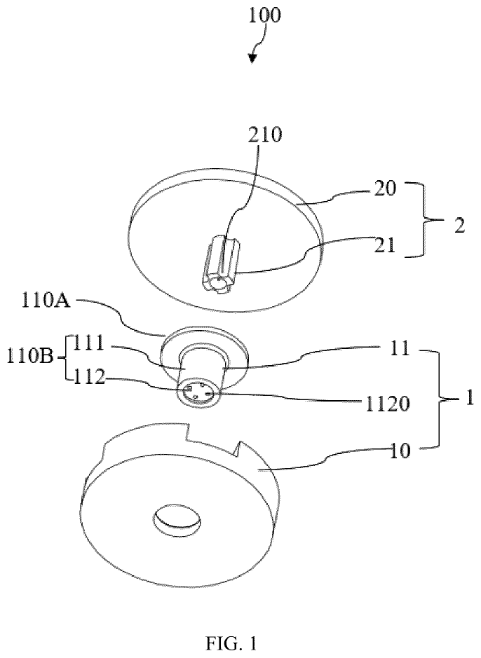

As shown in FIGS. 1-11, an embodiment of the present disclosure provides a water outlet device 100, which may include a jet disk 1 and a cover body 2 installed cooperatively with the jet disk 1 to form a water flow channel.

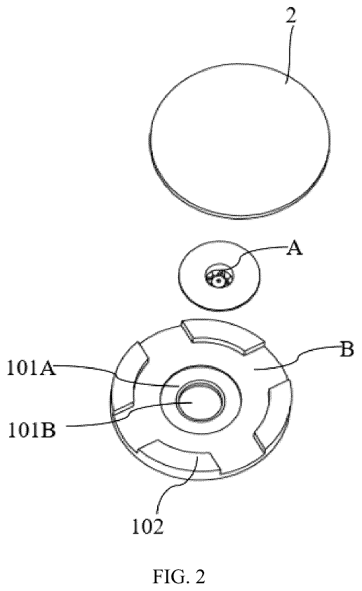

As shown in FIGS. 1-2, the jet disk 1 may include a disk body 10, the disk body 10 may have a first disk surface (a top surface of the disk body 10 shown in the figures) and a second disk surface (a bottom surface of the disk body 10 shown in the figures) that are opposite to each other. The jet disk 1 may further include a nozzle part 11 provided on the disk body 10 and extending out of the second disk surface. The nozzle part 11 may include a sidewall 111 and a bottom wall 112 enclosing a hollow cavity A, and the bottom wall 112 of the nozzle part 11 may be provided with a water outlet hole 1120.

In an embodiment of the present disclosure, the nozzle part 11 and the disk body 10 may be of a split assembly structure. In an exemplary embodiment, the nozzle part 11 and the disk body 10 may be an integrated molding structure, for example, may be integrally formed by casting, in which the disk body 10 can be molded first, and then the nozzle part 11 and the disk body 10 can be integrally cast molded.

In an embodiment of the present disclosure, the disk body 10 may be a circular plate shape, and its main function is to support the nozzle part 11. Alternatively, the disk body 10 may be square, cylindrical, or other shapes. The specific shape and dimension of the disk body 10 are not limited herein.

In an embodiment of the present disclosure, the hollow cavity A of the nozzle part 11 is in the shape of a tank, which can be used for water flow to enter and be ejected outward. Alternatively, the nozzle part 11 may be other shape such as a cuboid, a cone, and will not be limited herein.

As shown in FIGS. 1-2, the cover body 2 may include a cover plate 20, and the cover plate 20 may have a first plate surface (a top surface of the cover plate 20 shown in the figures) and a second plate surface (a bottom surface of the cover plate 20 shown in the figures) that are opposite to each other, and the cover body 2 may further include an extension part 21 extending from the second plate surface towards the first disk surface of the disk body 10 and into the hollow cavity A of the nozzle part 11.

In an embodiment of the present disclosure, the cover plate 20 may be in the shape of a circular plate, an overall shape of the cover plate 20 may be conformed to a shape of the disk body 10, and its main function is to arrange the extension part 21. Alternatively, the cover plate 20 may be shaped like a bottle cap or other shapes. A dimension of the cross-section of the cover plate 20 may be the same as a dimension of the cross-section of the disk body 10, or may be larger or smaller than the dimension of the cross-section of the disk body 10. The specific shape and dimension of the cover plate 20 can be set according to the actual situation, and will not be limited herein.

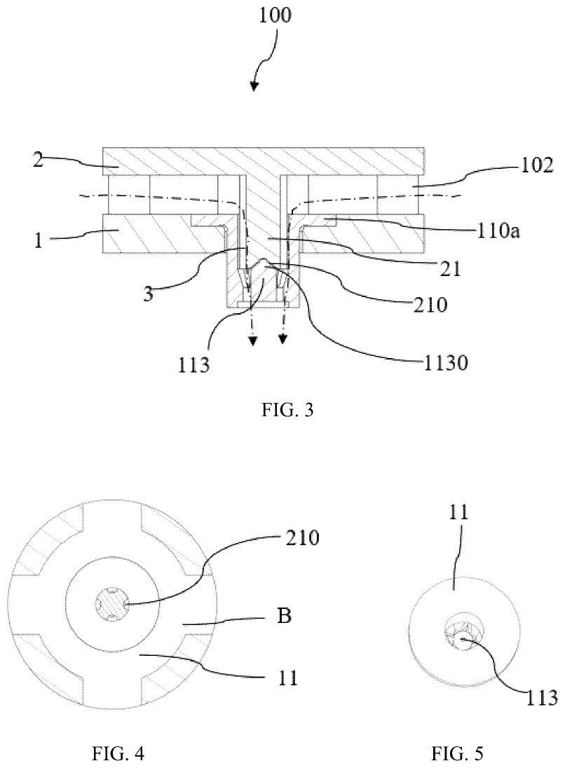

As shown in FIG. 3, when the jet disk 1 and the cover body 2 are fitted cooperatively, the second disk surface of the disk body 10 may be opposite to the first plate surface of the cover plate 20, and the extension part 21 of the cover plate 20 may extend into the hollow cavity A of the nozzle part 11. A water jet channel 3 can be formed by spacing between an outer wall surface of the extension part 21 and an inner wall surface of the sidewall 111 of the nozzle part 11. A water outlet end of the water jet channel 3 can communicate with the water outlet hole 1120 of the bottom wall 112 of the nozzle part 11 to jet the water flow (a flow direction of the water flow is shown in a direction indicated by a dotted arrow in FIG. 3).

In an embodiment of the present disclosure, multiple water outlet holes 1120 can be included, and the water flow enters the water jet channel 3 and is sprayed out of the water outlet holes 1120 to form a drizzle-like water flow.

In an embodiment of the present disclosure, the cover body 2 of the water outlet device 100 is provided with an extension part 21, and a water jet channel 3 are formed by spacing between an outer wall surface of the extension part 21 and an inner wall surface of the sidewall 11 of the nozzle part 11, so that the water pressure can be concentrated on the sidewall 111 of the nozzle part 11, thus stabilizing the dimension of the nozzle part 11 to prevent the hollow cavity A of the nozzle part 11 from being affected by water pressure, which in turn may cause the expansion and deformation of the nozzle part 11, resulting in unstable outlet water shape. At the same time, maintaining the dimensional stability of the nozzle part 11 can further prevent the nozzle part 11 from being deformed and damaged, and improve the service life of the nozzle part 11.

As shown in FIGS. 1-2, the nozzle part 11 may further include an annular stop part 110A, and a spray tube part 110B extending from the annular stop part 110 in a direction toward the second disk surface of the disk body 10, and the spray tube part 110B may extend out of the second disk surface of the disk body 10 (as shown in FIG. 3). A portion of the spray tube part 110B extending out of the second disk surface of the disk body 10 is convenient for a user to knead and clean the nozzle part 11 to achieve the purpose of descaling.

In an exemplary embodiment, a ratio of a length of the nozzle part 11 provided in the disk body 10 to a length of the nozzle part 11 extending out of the disk body 10 can range from 0.13 to 7, thereby avoiding expansion of the nozzle part 11 and achieving a stable outlet water effect.

As shown in FIG. 2, the disk body 10 may further include a countersunk groove 101A that is recessed inwardly from the first disk surface of the disk body 10, and a through hole 101B that communicates with the countersunk groove 101A and the second disk surface of the disk body 10. The annular stop part 110 of the nozzle part 11 may be installed in the countersunk groove 101A of the disk body 10, and may cooperate with the countersunk groove 101A to limit the position, so that the nozzle part 11 may be prevented from falling out of the jet disk 1 due to the impact of water flow and the nozzle part 11 may be prevented from shaking along a radial direction of the jet disk 1 simultaneously. The spray tube part 110B can extend out of the second disk surface through the through hole 101B.

As shown in FIG. 3, the spray tube part 110B of the nozzle part 11 may be installed in a gap with the through hole 101B. There may be a gap between an inner wall surface 1011 of the through hole 101B and an outer wall surface of the spray tube part 110B of the nozzle part 11. On one hand, this gap facilitates the assembly and installation of the nozzle part 11 and the jet disk 1. On the other hand, when water flow enters the nozzle part 11, a certain space for expansion and deformation can be given to the nozzle part 11, so as to prevent excessive expansion of a part of the nozzle part 11 extending out of the jet disk 1, which results in instability of the outlet water shape.

In an embodiment of the present disclosure, a material hardness of the nozzle part 11 may be designed to be smaller than a material hardness of the disk body 10. The nozzle part 11 may be made of a soft material with less hardness, which is beneficial for user to knead for cleaning and descaling. The nozzle part 11 may be generally made of an elastic material such as rubber or silicone, and the disk body 10 and the cover body 2 may be generally made of a rigid material such as a rigid plastic material.

As shown in FIGS. 1 and 4, the outer wall surface of the extension part 21 may be provided with multiple grooves 210 arranged at intervals along a circumferential direction thereof and the grooves 210 may extend along an axial direction of the extension part 21. The multiple grooves 210 cooperate with the inner wall surface of the sidewall 111 of the nozzle part 11 to form multiple water jet channels 3, so that it is possible to prevent the dimension of the nozzle part 11 from being unstable due to the expansion of the nozzle part 11 due to the excessive flow rate and pressure of the water entering the nozzle part 11.

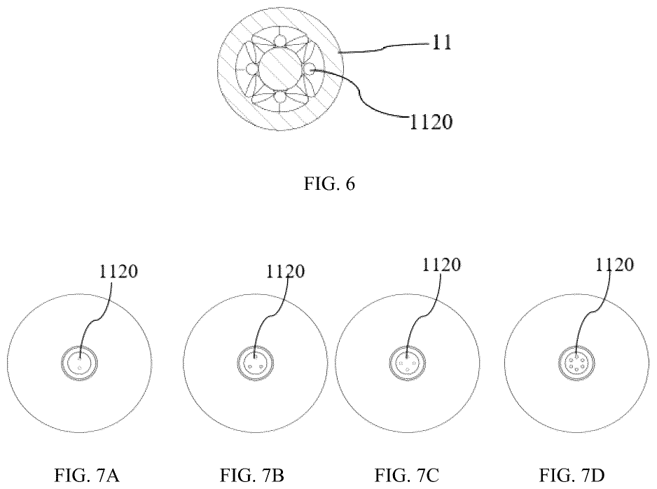

As shown in FIGS. 3 and 5, the bottom wall 112 of the nozzle part 11 may be provided with a protruding part 113 that protrudes into the hollow cavity A of the nozzle part 11, and the water outlet holes 1120 may be arranged on the outer periphery of the protruding part 113 (as shown in FIG. 6). The extension part 21 of the cover plate 2 and the protruding part 113 of the nozzle part 11 may be provided with a nested cooperating structure that cooperates with each other. The extension part 21 and the protruding part 113 may be provided with the nested cooperating structure. On one hand, when the jet disk 1 and the cover body 2 are fitted cooperatively, the extension part 21 can be precisely positioned to maintain the uniformity and stability of the outlet water. On the other hand, when the nozzle part 11 is descaled and cleaned, the extension part 21 can be shaken to improve the descaling effect, and at the same time, the extension part 21 can return to the initial position after descaling and cleaning.

As shown in FIG. 3, the nested cooperating structure may include a tapered protrusion 1130 provided on one of the protruding part 113 and the extension part 11, and a tapered groove 210 provided on the other one of the protruding part 113 and the extension part 11. The tapered protrusion 1130 may be inserted into the tapered groove 210 and may be nested with the tapered groove 210.

In an embodiment of the present disclosure, the water outlet device 100 can increase the strength of the bottom wall 112 of the nozzle part 11 by providing the protruding part 113 in the nozzle part 11, and at the same time, the water pressure is concentrated on the sidewall of the nozzle part 11, thereby preventing the bottom wall 112 of the nozzle part 11 from being deformed.

In an exemplary embodiment, a ratio of a flow area of the water jet channel(s) 3 of the nozzle part 11 to a flow area of the water outlet hole(s) 1120 may range from 0.15 to 2, so that a better water outlet pressure and flow rate can be maintained, expansion can be avoided, and a stable water profile of the outlet water can be maintained.

In an embodiment of the present disclosure, the flow area of the water jet channel(s) 3 of the water outlet device 100 may be greater than the flow area of the water outlet hole(s) 1120, so that the water flow has a certain jet flow velocity.

As shown in FIGS. 3 and 6, one end of the hollow cavity A close to the water outlet hole(s) 1120 may be contracted to form a communication part between the water jet channel(s) 3 and the water outlet hole(s) 1120. One end of the hollow cavity A close to the water outlet hole(s) 1120 is contracted, which can increase the flow velocity of the water flow and achieve the effect of jetting.

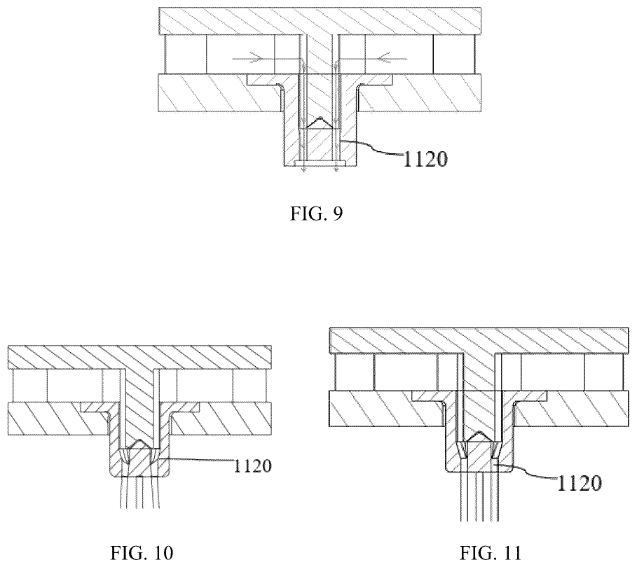

In an exemplary embodiment, one end of the hollow cavity A close to the water outlet hole(s) 1120 may not be contracted. As shown in FIG. 9, the water outlet ends of the water jet channels 3 correspond to the water outlet holes 1120 one by one in an outlet water direction, and the water flow may directly enter the water outlet holes 1120 to be ejected without accelerating or increasing the water flow.

As shown in FIG. 2, multiple projections 102 provided at intervals may be disposed on the disk surface (the first disk surface) of the disk body 10 opposite to the cover body 2. The multiple projections 102 may separate the cavity between the disk body 10 and the cover plate 20 into multiple channels to form water inlet channels B. The water inlet channels B may extend radially along the disk body 10.

In an exemplary embodiment, the projections 102 may be provided on the plate surface of the cover body 2 opposite to the disk body 10. When water flows into the water outlet device 100, it may flow into the water jet channels 3 from multiple water inlet channels B circumferentially spaced, and then is sprayed out of the water outlet holes 1120.

As shown in FIGS. 7A-7D, the water outlet holes 1120 of the nozzle part 11 may include a variety of shapes, such as circle, square, triangle. A quantity of the water outlet holes 1120 may be various, for example, 2, 3, 4, or 6, which may be specifically determined according to the actual situation. By designing the shape, dimension, and quantity of the water outlet holes 1120 of the nozzle part 11, different shapes of water flow and different quantities of water columns of drizzle water can be realized.

In an embodiment of the present disclosure, as shown in FIG. 11, the extension direction of the water outlet holes 1120 of the nozzle part 11 may be parallel to an axial direction of the nozzle part 11 so that the nozzle part 11 can eject a vertical water spray.

In an exemplary embodiment as shown in FIG. 10, an included angle may be formed between the extension direction of the water outlet holes 1120 of the nozzle part 11 and the axial direction of the nozzle part 11 so that the nozzle part 11 can eject an inclined water spray. The included angle can be about 0-30 degrees, which can be specifically designed according to the required water spray shape. When the water outlet device 100 is applied to a shower head, the inclined water spray ejected by multiple nozzle parts 11 arranged on an end face of the shower head can form various three-dimensional water shapes, such as a staggered slim waistline shape.

In an embodiment of the present disclosure, the nozzle part 11 can obtain various forms of stable water shapes by designing the shape of the water outlet hole(s) 1120.

In an embodiment of the present disclosure, the multiple water outlet holes 1120 and the multiple water jet channels 3 can be provided in one-to-one correspondence (the multiple water outlet holes 1120 can be communicated in one-to-one correspondence with the multiple water jet channels 3), which can conduct one-to-one drainage of the inlet water, so as to prevent the nozzle part 11 from being deformed due to pressure suppression. At the same time the water pressure is concentrated on the sidewall of the nozzle part 11 to prevent a center of the nozzle part 11 from being deformed.

In an exemplary embodiment, the multiple water outlet holes 1120 and the multiple water jet channels 3 may not be provided in one-to-one correspondence. For example, when an amount of water flow is greater, it may not be necessary to provide the water outlet holes 1120 and the multiple water jet channels 3 in one-to-one correspondence. In an example, the water outlet holes 1120 and the multiple water jet channels 3 may be staggered along the radial direction of the bottom wall 112.

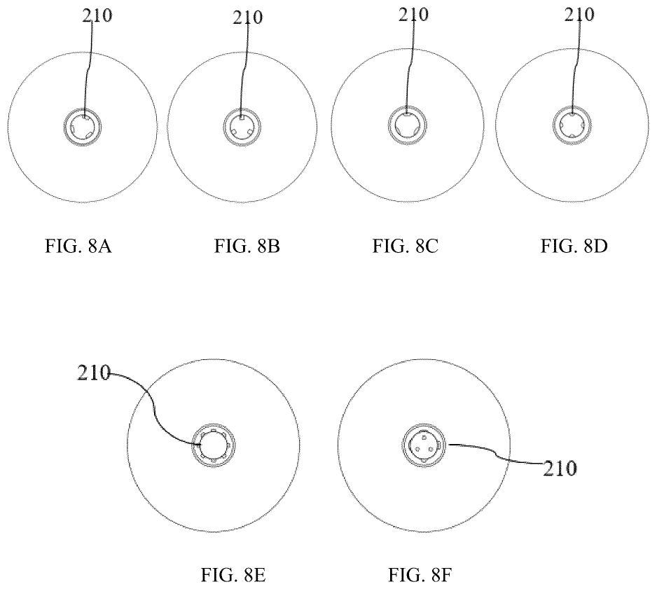

As shown in FIGS. 8A-8D, the multiple grooves 210 may be provided on the sidewall of the extension part 21. A quantity of the multiple grooves 210 may be 2 to 8, or the like, and the shape of the multiple grooves 210 may be square, arc, or the like, which may be specifically set according to the actual situation, and will not be limited herein.

As shown in FIGS. 8E-8F, the multiple grooves 210 may be provided on the inner wall surface of the nozzle part 11, and may cooperate with the outer wall surface of the extension part 21 to form the water jet channels 3. The quantity of the multiple grooves 210 can be specifically set according to the actual situation, which is not limited herein.

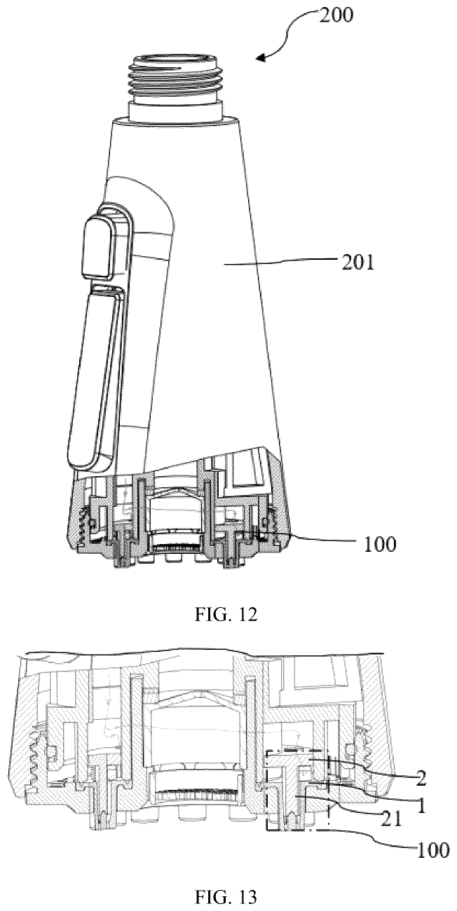

As shown in FIGS. 12 and 13, an embodiment of the present disclosure further provides a faucet 200, which may include a faucet main body 201 and the water outlet device 100 installed at a water outlet end of the faucet main body 201 as described in any of the aforementioned embodiments (referring to a portion of the water outlet device 100 inside a dashed box shown in FIG. 13). The water outlet device 100 may be disposed at the water outlet end of the faucet main body 201, so that the water outlet device 100 is integrally disposed at the water outlet end of the faucet 100, and a water inlet channel of the water outlet device 100 may be communicated with a water inlet channel of the faucet main body 201.

In an embodiment of the present disclosure, there are multiple water outlet devices 100. The cover plates 20 of the multiple water outlet devices 100 may be of an integral design, and multiple extension parts 21 may be arranged on the cover plates 20. The disk bodies 10 of the multiple water outlet devices 100 may be of an integral design, and multiple nozzle parts 11, a quantity of which is equal to a quantity of the extension parts 21, may be provided on the disk bodies 10. The integral design of the cover plate 20 and the disk body 10 may facilitate assembly.

In an exemplary embodiment, the cover plates 20 of the multiple water outlet devices 100 may be of a split design, and the disk bodies 10 of the multiple water outlet devices 100 may be of a split design.

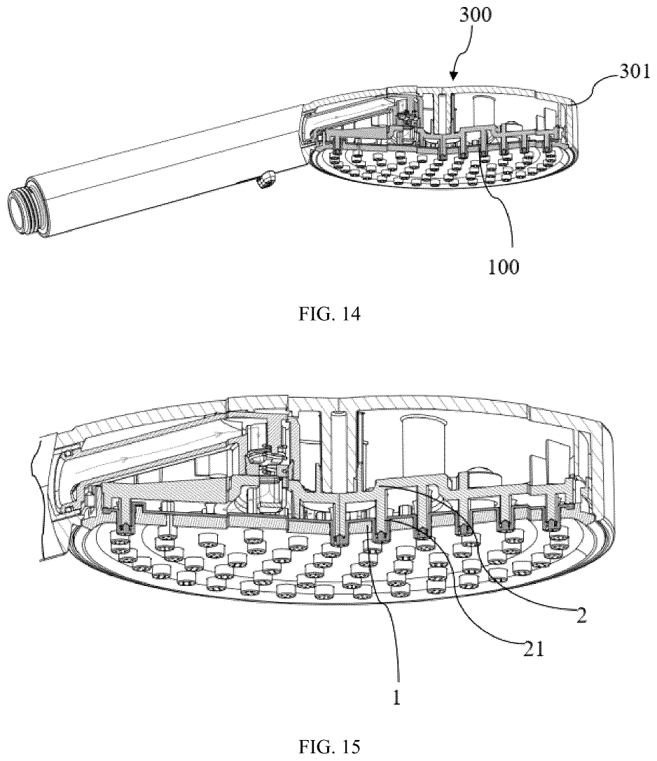

As shown in FIGS. 14 and 15, an embodiment of the present disclosure also provides a shower head 300, which may include: a shower head main body 301 and the water outlet device 100 installed on the shower head main body 301 as described in any of the aforementioned embodiments. The water outlet device 100 may be provided at a water outlet end of the shower head main body 301, so that the water outlet device 100 is integrally provided at a water outlet end of the shower head 300, and a water outlet channel of the water outlet device 100 may be communicated with a water inlet channel of the shower head main body 301.

In an embodiment of the present disclosure, there are multiple water outlet devices 100, the cover plates 20 of the multiple water outlet devices 100 may be of an integral design, and multiple extension parts 21 may be arranged on the cover plates 20. The disk bodies 10 of the multiple water outlet devices 100 may be of an integral design, and multiple nozzle parts 11, a quantity of which is equal to a quantity of the extension parts 21, may be provided on the disk bodies 10. Similarly, the integral design of the cover plate 20 and the disk body 10 may facilitate assembly.

In an exemplary embodiment, the cover plates 20 of the multiple water outlet devices 100 may be of a split design, and the disk bodies 10 of the multiple water outlet devices 100 may be of a split design.

In an embodiment of the present disclosure, the water outlet device 100 can conduct one-to-one drainage of the inlet water. The disk body 10 can be made of hard rubber that does not deform due to water pressure, while the water pressure can be concentrated on the sidewall of the nozzle part 11 to prevent a center of the nozzle part 11 from deforming. At a higher water pressure, the through hole 101B of the disk body 10 made of hard rubber and a part of the nozzle part 11 made of rubber located in the through hole 101B form a flow restriction, so that the pressure of inflowing water will not be too large, ensuring that the dimension of the bottom wall of the nozzle part 11 made of rubber is stable and the outlet water effect is good.

In an embodiment of the present disclosure, a tapered protrusion 1130 may be added in the hollow cavity A of the nozzle part 11. The tapered protrusion 1130 may be cooperates with the tapered groove 210 of the extension part 21 of the cover body 2, so as to facilitate assembly while increasing strength, and improve assembly efficiency and dimensional stability.

In an embodiment of the present application, the water outlet device 100 has a simple structure, a dimension of a water outlet hole 1120 of the nozzle part 11 is stable, the outlet water effect is good, and the user experience is good.

In the description of the present specification, descriptions with reference to terms “one embodiment”, “certain embodiments”, “schematic embodiments”, “examples”, “specific examples”, or “some examples” and the like mean that specific features, structures, materials, or characteristics described in connection with the implementations or examples are included in at least one implementation or example of the embodiments of the present disclosure. In this specification, schematic representations of the above terms do not necessarily refer to the same implementations or examples. Further, the specific features, structures, materials, or characteristics described may be combined in a suitable manner in any one or more implementations or examples.

Although implementations disclosed herein are described above, the described contents are only implementations used for facilitating understanding of the present application, and are not intended to limit the present application. Without departing from the spirit and scope disclosed herein, any person skilled in the art to which the present application pertains may make any modifications and changes in the form and details of implementation, but the scope of patent protection of the present application shall still be defined by the appended claims.

1. A water outlet device, comprising: a jet disk and a cover body, wherein the jet disk comprises a disk body, the disk body has a first disk surface and a second disk surface that are opposite to each other, and the jet disk further comprises a nozzle part provided on the disk body and extending out of the second disk surface, wherein the nozzle part comprises a sidewall and a bottom wall enclosing a hollow cavity, and the bottom wall of the nozzle part is provided with a water outlet hole;
wherein the cover body comprises a cover plate which is installed cooperatively with the disk body to form a water inlet channel, the cover plate has a first plate surface and a second plate surface that are opposite to each other, the cover body further comprises an extension part extending from the second plate surface toward the first disk surface and extending into the hollow cavity, a water jet channel is formed by an outer wall surface of the extension part and an inner wall surface of a sidewall of the nozzle part, and a water outlet end of the water jet channel communicates with the water outlet hole.

2. The water outlet device according to claim 1, wherein the bottom wall of the nozzle part is provided with a protruding part protruding into the hollow cavity of the nozzle part, a nested cooperating structure is provided between the extension part and the protruding part, and the water outlet hole is arranged on an outer periphery of the protruding part.

3. The water outlet device according to claim 2, wherein the nested cooperating structure comprises a tapered protrusion provided on one of the protruding part and the extension part, and a tapered groove provided on the other one of the protruding part and the extension part, and the tapered protrusion extends into the tapered groove.

4. The water outlet device according to claim 1, wherein the nozzle part comprises an annular stop part and a spray tube part extending from the annular stop part in a direction away from the second disk surface;
the disk body comprises a countersunk groove which is inwardly recessed from the first disk surface of the disk body, and a through hole which communicates the countersunk groove and the second disk surface; the annular stop part of the nozzle part is installed in the countersunk groove of the disk body, and the spray tube part extends out of the second disk surface from the through hole.

5. The water outlet device according to claim 4, wherein there is an installation gap between an inner wall surface of the through hole of the disk body and an outer wall surface of a sidewall of the spray tube part.

6. The water outlet device according to claim 1, wherein the outer wall surface of the extension part or the inner wall surface of the sidewall of the nozzle part is provided with a plurality of grooves arranged at intervals along a circumferential direction, the grooves extending along an axial direction of the extension part or an axial direction of the nozzle part;
the plurality of grooves on the outer wall surface of the extension part cooperate with the inner wall surface of the sidewall of the nozzle part to form a plurality of water jet channels, or the plurality of grooves on the inner wall surface of the sidewall of the nozzle part cooperate with the outer wall surface of the extension part to form a plurality of water jet channels.

7. The water outlet device according to claim 6, wherein there are a plurality of water outlet holes, and the plurality of water outlet holes are provided in one-to-one correspondence with the plurality of water jet channels.

8. The water outlet device according to claim 6, wherein an extension direction of the water outlet hole is parallel to the axial direction of the nozzle part, or an included angle is formed between the extension direction of the water outlet hole and the axial direction of the nozzle part.

9. The water outlet device according to claim 1, wherein a flow area of the water jet channel is greater than a flow area of the water outlet hole; and
one end of the hollow cavity close to the water outlet hole is contracted to form a communication part between the water jet channel and the water outlet hole.

10. The water outlet device according to claim 1, wherein the nozzle part and the disk body are of a split assembly structure or an integrated molding structure.

11. The water outlet device according to claim 1, wherein a plurality of projections arranged at intervals are provided on the first disk surface of the disk body or on the second plate surface of the cover body;
wherein the water inlet channel is formed by spacing between the plurality of projections and the water inlet channel extends along a radial direction of the disk body.

12. The water outlet device according to claim 1, wherein a material hardness of the nozzle part is less than a material hardness of the cover body, and is less than a material hardness of the disk body.

13. The water outlet device according to claim 1, wherein the nozzle part is made of an elastic material and the disk body is made of a rigid material.

14. The water outlet device according to claim 1, wherein a ratio of a flow area of the water jet channel of the nozzle part to a flow area of the water outlet hole ranges from 0.15 to 2.

15. The water outlet device according to claim 1, wherein a ratio of a length of the nozzle part provided in the disk body to a length of the nozzle part extending out of the disk body ranges from 0.13 to 7.

16. A faucet comprising the water outlet device according to claim 1, wherein the water outlet device is provided at a water outlet end of the faucet.

17. A shower head comprising the water outlet device according to claim 1, wherein the water outlet device is provided at a water outlet end of the shower head.

18. The water outlet device according to claim 2, wherein the nozzle part comprises an annular stop part and a spray tube part extending from the annular stop part in a direction away from the second disk surface;
the disk body comprises a countersunk groove which is inwardly recessed from the first disk surface of the disk body, and a through hole which communicates the countersunk groove and the second disk surface; the annular stop part of the nozzle part is installed in the countersunk groove of the disk body, and the spray tube part extends out of the second disk surface from the through hole.

19. The water outlet device according to claim 2, wherein the outer wall surface of the extension part or the inner wall surface of the sidewall of the nozzle part is provided with a plurality of grooves arranged at intervals along a circumferential direction, the grooves extending along an axial direction of the extension part or an axial direction of the nozzle part;
the plurality of grooves on the outer wall surface of the extension part cooperate with the inner wall surface of the sidewall of the nozzle part to form a plurality of water jet channels, or the plurality of grooves on the inner wall surface of the sidewall of the nozzle part cooperate with the outer wall surface of the extension part to form a plurality of water jet channels.

20. The water outlet device according to claim 2, wherein a flow area of the water jet channel is greater than a flow area of the water outlet hole; and
one end of the hollow cavity close to the water outlet hole is contracted to form a communication part between the water jet channel and the water outlet hole.
